(19) United States
(12) Patent Application Publication
(10) Pub. No.: US 2006/0067499 A1
(43) Pub. Date: Mar. 30, 2006

(54) Method and apparatus for querying a list of participants in a conference

(76) Inventors: Marcelo Oliveira, San Jose, CA (US); Saravanakumar V. Tiruthani, Santa Clara, CA (US)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 10/957,172

(22) Filed: Sep. 30, 2004

(51) Int. Cl. H04M 3/42

(52) U.S. Cl. 379/202.01

(57) ABSTRACT

A telecommunications apparatus includes a teleconferencing service; and a participant list announcement service operably coupled to the teleconferencing service and configured to announce the names of active participants in a teleconference to a requesting participant.

### BACKGROUND OF THE INVENTION

1. Field of the Invention

The present invention relate to telecommunications systems and, in particular, to an improved conferencing system.

2. Description of the Related Art

Modern teleconferencing systems allow three or more users to participate in the same call. To establish a conference call, a host may reserve and/or arrange a time for the conference and a number of connections on a conferencing server or bridge.

To join the conference, participants may dial in to the server and enter an access code. At this time, they may also speak their names, which can be announced to other users when they join the conference.

Alternatively, when the host makes arrangements, he may provide the server with the identities and telephone numbers of conference participants. The conferencing server itself may then dial out to the participants at the prearranged time.

While the conferencing server may announce the names of participants as they join, there is no way for participants to determine who else is in the conference. Consequently, each time a new participant “arrives,” the conference is interrupted, not only by the server announcing the new arrival, but by the new arrival asking who else is already present. As can be appreciated, as the number of participants increases, this can eat up a significant amount of time.

As such, there is a need for an improved teleconferencing system. There is a further need for a system for determining the names of participants to an ongoing conference.

### SUMMARY OF THE INVENTION

These and other drawbacks in the prior art are overcome in large part by a system and method according to embodiments of the present invention.

A telecommunications apparatus according to embodiments of the present invention includes a teleconferencing service; and a participant list announcement service operably coupled to the teleconferencing service and configured to announce the names of active participants in a teleconference to a requesting participant. In certain embodiments the participant list announcement service is configured to announce the names only to the requesting party. In certain embodiments, the participant list announcement service is configured to announce the names aurally. In some embodiments, the participant list announcement service is configured to cause an audio file to be downloaded to the requesting party, the audio file including the names of the participants for announcing aurally. In some embodiments, the participant list announcement service is configured to send an e-mail containing a text list of names of participants to the requesting party. In some embodiments, the participant list announcement service is configured to generate an aural list of active participants from a text list. In some embodiments, the participant list announcement service is configured to generate an aural list of active participants from names directly spoken by joining participants. In some embodiments, the text list is provided when a teleconference is scheduled through said teleconferencing service. In some embodiments, the participant list is sent as an Instant message to the participant who has requested to see the list of participants. In some embodiments, the participant lists can be sent to all the members as a multi-party instant message.

A method in accordance with embodiments of the present invention includes receiving a request for a list of active participants to a teleconference; and providing the list to a requesting party. In certain embodiments, the providing includes providing the list as an audio announcement only to the requesting party. In some embodiments, the providing further includes providing the audio announcement in the foreground while the conference is ongoing in the background. In some embodiments, the providing includes generating an e-mail including the list and sending the e-mail to the requesting party. The e-mail may include an audio file of the list or a text representation of the list. In some embodiments, the providing comprises generating an audio representation of a name of a participant from a textual representation.

### BRIEF DESCRIPTION OF THE DRAWINGS

The present invention may be better understood, and its numerous objects, features, and advantages made apparent to those skilled in the art by referencing the accompanying drawings. The use of the same reference symbols in different drawings indicates similar or identical items.

FIG. 1 is a diagram schematically illustrating a system according to embodiments of the present invention.

FIG. 2 is a block diagram illustrating a system according to an embodiment of the present invention.

FIG. 3 is a flowchart illustrating operation of an embodiment of the present invention.

FIG. 4 is a flowchart illustrating operation of an embodiment of the present invention.

FIG. 5 is a flowchart illustrating operation of an embodiment of the present invention.

FIG. 6A and FIG. 6B are flowcharts illustrating operation of embodiments of the present invention.

FIG. 7 is a block diagram of a user device according to an embodiment of the present invention.

FIG. 8 is a block diagram of a server according to an embodiment of the present invention.

### DETAILED DESCRIPTION OF EMBODIMENTS OF THE INVENTION

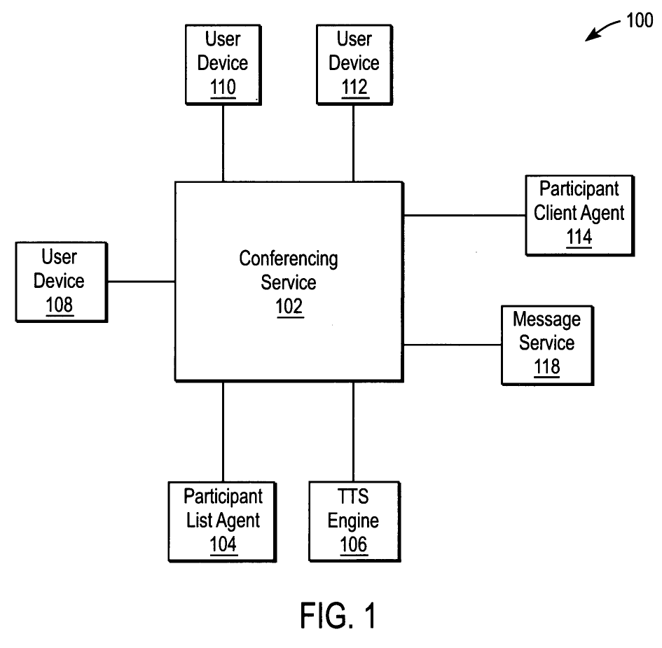

Turning now to the drawings and, with particular attention to FIG. 1, a diagram of a telecommunications system 100 according to an embodiment of the present invention is shown. The system includes a conferencing service 102 connected to or in communication with a participant list agent/announcement service 104, a text-to-speech engine 106, and a messaging service, such as an e-mail service or a text service 118.

User devices, such as user devices 108, 110, 112 may be connected to or in communication with the conferencing service 102 and the e-mail service 118. In some embodiments, the conferencing service 102 may couple to, communicate with, or include a telephony service (not shown). In certain embodiments, the user devices may be implemented as telephones, cellular telephones, PDAs, computers, etc. For example, a user device 108, 110, 112 may be embodied as personal computers implementing the Windows XP operating system, the Windows Messenger instant messaging system, and the Explorer web browser. In addition, the user devices 108, 110, 112 may include telephony and other multimedia messaging capability using, for example, peripheral cameras, Webcams, microphones, and speakers (not shown) or peripheral telephony handsets, such as the Optipoint handset available from Siemens Information and Communication Networks, Inc. The user devices may implement one or more participant list client applications 114.

In certain embodiments, the system 100 may also include other hardware and/or software components (e.g., gateways, proxy servers, registration server, presence servers, redirect servers, databases, applications, etc.) such as, for example, hardware and software used to support a SIP (Session Initiation Protocol) or other protocol based infrastructure for the system 100 and allow the registration of SIP devices in the system 100.

The conferencing service 102 may be implemented, for example, as a conferencing bridge or a multipoint conferencing unit (MCU) or any device or group of devices capable of functioning as a bridge for teleconferences. For example, the conferencing service 102 may include capability of mixing and supervising multiple party connections.

In particular, in certain embodiments, the conferencing service 102 may function in either or both of a “dialing out” mode and a “meet me” mode for setting up the teleconference. In the “dialing out” mode, a conference host (typically, any user with an appropriately equipped device or access to one) accesses the conferencing service 102, for example, via a browser-based interface, and schedules the conference by inputting time, date, and participant names and telephone numbers. When the scheduled time occurs, the conferencing service 102 dials out to the participants to start the conference.

In the “meet me” mode, the host can reserve a plurality of ports with the service and establish a conference identifier. Participants can then call in to the conferencing service, enter the identifier, and be connected to the conference.

The conferencing service 102 may be implemented in hardware and/or software operating on one or more servers, computer systems, host or mainframe computers, workstations, etc. In some embodiments, the conferencing service 102 may be operating on some or all of the same devices as other components in the system 100.

The participant list agent 104 functions to monitor active participants in a teleconference and, upon request, provide a list of the participants to a requesting party. The list may be provided aurally to the requesting party such that other participants in the conference do not hear the listing. In certain embodiments, the listing may be played in the foreground while the conference itself plays in the background. In other embodiments, the listing may be provided as audio or text in association with a messaging system, such as an attachment to an e-mail to the requesting party. The participant list agent 102 may be implemented in hardware and/or software operating on one or more servers, computer systems, host or mainframe computers, workstations, etc. In some embodiments, the participant list agent 102 may be operating on some or all of the same devices as other components in the system 100.

The text-to-speech (TTS) agent 106 may function in conjunction with the conferencing service 102 to provide users with the list of active participants. For example, in certain embodiments, the TTS agent 106 can access the list of participants input by the host when scheduling the conference (e.g., a “dialing out” conference, although it is noted that the host or another user could also input names textually for a “meet me” conference). The TTS agent 106 may receive a command from the participant list service 104 to perform a text-to-speech conversion on the textual representations of the active participants (as provided by the participant list service). The output of the TTS agent 106 may then be provided to the participant list service 102 and transmitted to the requesting party aurally. The TTS agent 106 may be implemented in hardware and/or software operating on one or more servers, computer systems, host or mainframe computers, workstations, etc. In some embodiments, the TTS agent 106 may be operating on some or all of the same devices as other components in the system 100.

The messaging service 118 may be embodied as an e-mail service that may implement e-mail server functions for one or more users. In addition, the e-mail service may operate in conjunction with the participant list service 102 and/or the TTS agent 106 to provide lists of active participants to a requesting user. For example, in response to a request from a party for a list of active participants, in certain embodiments, the participant list service 102 provides the associated audio file or files to the e-mail service 1 18. The e-mail service attaches the audio file or files and e-mails the list to the requesting user. In other embodiments, the e-mail service 118 may receive a textual representation of the active participants list. These may be attached as e-mail and sent to the requesting user. In still other embodiments, a textual list is provided to the TTS agent 106, which converts the text to speech, saves the result as an audio file, and provides the audio file to the e-mail service 118 for transmission to the requesting user.

An exemplary e-mail service 118 is Microsoft Outlook. The e-mail service 118 may be implemented in hardware and/or software operating on one or more servers, computer systems, host or mainframe computers, workstations, etc. In some embodiments, the e-mail service 118 may be operating on some or all of the same devices as other components in the system 100.

In embodiments in which the messaging service 118 is a text messaging service, the participant list can be provided as text in an instant message to the user. Alternatively, the text message could be provided to all members of the conference. The text can be generated in a manner similar to that discussed above. Exemplary instant messaging services are available from Microsoft and AOL.

In addition, one or more participant list client applications 114 may be provided. The participant list client applications 114 allow users to request participant lists and generally interact with the participant list service 104. The participant list client applications may be implemented as including any suitable interface, including for example such as browser-type interfaces, as DTMF (dual tone multi-frequency) interfaces, or voice command interfaces. As noted above, the participant list client applications 114 may be implemented on the user devices, for example as part of telephony or conferencing programs or clients. More generally, the participant list client applications 114 may be implemented in hardware and/or software operating on one or more servers, computer systems, host or mainframe computers, workstations, etc. In some embodiments, the participant list client applications 114 may be operating on some or all of the same devices as other components in the system 100.

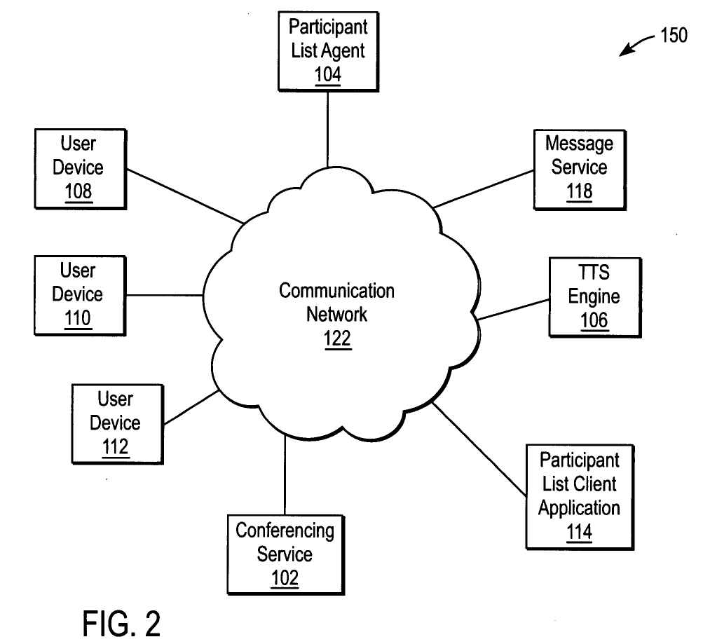

In certain embodiments of the present invention, one or more of the components of the system 100 may be connected to or in communication with each other via a communication network. For example, turning now to FIG. 2, a system 150 including the components of the system 100 is illustrated, wherein some or all of the components are in communication via a network 122. The network 122 may be or include the Internet, World Wide Web, a local area network, or some other public or private computer, cable, telephone, client/server, peer-to-peer, or communication network or intranet. In some embodiments, the communication network can also include other public and/or private wide area networks, local area networks, wireless networks, data communications networks, or connections, intranets, routers, satellite links, microwave links, cellular or telephone networks, radio links, fiber optic transmission lines, ISDN lines, T1 lines, DSL connections, the public switched telephone network (PSTN), etc. Moreover, as used herein, communications include those enabled by wired or wireless technology. In some embodiments, some or all of the network 122 may be implemented using a TCP/IP network and may implement voice or multimedia over IP using, for example, the Session Initiation Protocol (SIP).

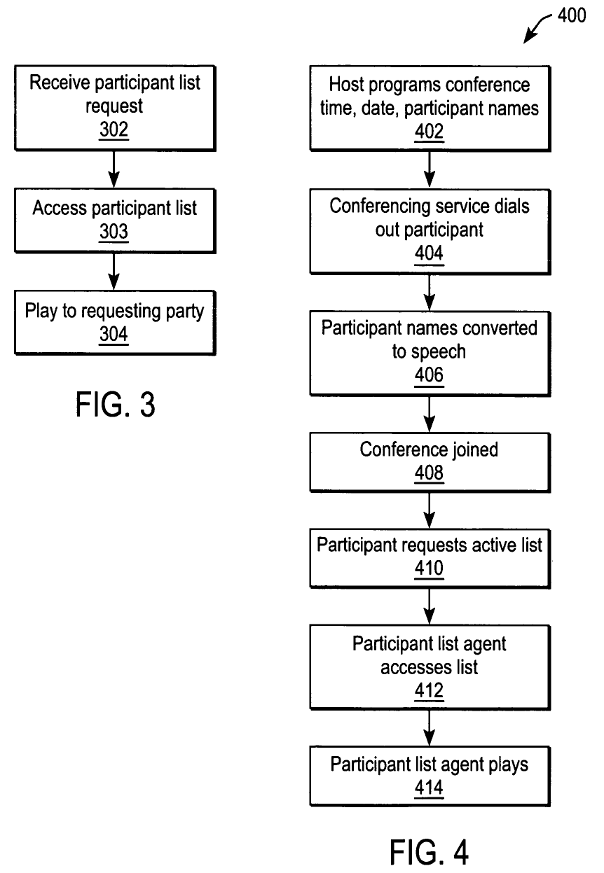

Turning now to FIG. 3, a flowchart 300 illustrating operation of embodiment of the present invention is shown. The particular arrangement of elements in the flowchart 300 is not meant to imply a fixed order to the elements; embodiments can be practiced in any order that is practicable.

In a step 302, the participant list agent 104 receives a request from a user for the list of active participants. For example, the user could be a user device employing a participant list client application 114. The request may be transmitted in a variety of ways. For example, if the user was employing a telephone or similar device having DTMF capability, the user could send one or more DTMF tones to be received at the participant list service 104. Alternatively, the request could be made via any suitable interface, including a browser-type interface, a DTMF interface, or a voice command interface.

In a step 304, the participant list agent 104 accesses the list of active participants. For example, the participant list agent 104 could query the conferencing service 102, which keeps track of the active conferences. The conferencing service 102 may periodically (or on some other basis) update the participant list agent 104 with the list of those currently active.

In a step 306, the participant list agent 104 can play or announce the list of active participants to the requesting party. For example, the participant list agent 104 could cause the conferencing server 102 to transmit as one or more audio streams the active participant list, or could cause the e-mail service 118 to send an e-mail or other message to the requesting user containing, e.g., text or an audio file of the names.

Turning now to FIG. 4, a flowchart 400 illustrating operation of embodiment of the present invention is shown. The particular arrangement of elements in the flowchart 400 is not meant to imply a fixed order to the elements; embodiments can be practiced in any order that is practicable.

In a step 402, a conference may be configured at the conferencing service 102. For example, a host or moderator can program the conference time, date, and participant names and contact numbers using a browser-type interface, or making arrangements with a human operator, etc. The conferencing service 102 stores the configuration information and accesses it at the appropriate time to begin the conference.

In a step 404, the conferencing service 102 calls out the programmed participants. For example, the conferencing service 102 accesses the programmed participant list and dials out there numbers.

In a step 406, the text-to-speech agent 106 may be used to convert the stored participant names to speech. That is, the participant names that were programmed by the host can be accessed or provided to the text-to-speech agent 106 and converted to an audio representation. The audio representation can be stored as an audio file. Alternatively, the host could speak the names of participants, which can then be stored as one or more audio files.

In a step 408, the conference may be activated or joined; the conferencing service 102 knows which participants are “active,” for example, by knowing the dial out numbers and by knowing which lines, ports, channels, etc., are busy. The conferencing service 102 may provide the names of active participants to the participant list agent 104.

In a step 410, the participant list agent 104 may receive a request for a participant list. As noted above, a user may make use of a participant client list application 114 to send one or more request signals to the participant list agent 104. This may include, for example, DTMF signaling or signaling through a browser interface, or any other suitable signaling.

At a step 412, the participant list agent 104 will access the list and/or identify which parties are active participants. The participant list agent 104 will also access the corresponding audio files of the names of active participants.

Finally, at a step 414, the participant list agent 104 will announce or play (or cause to be played) the list to the requesting party. For example, the conferencing service 102 could be caused to mix in the audio file(s) or stream to the requester's channel, but not the non-requesting parties' channels. The list can be played such that the list is heard in the foreground while the ongoing conference continues in the background.

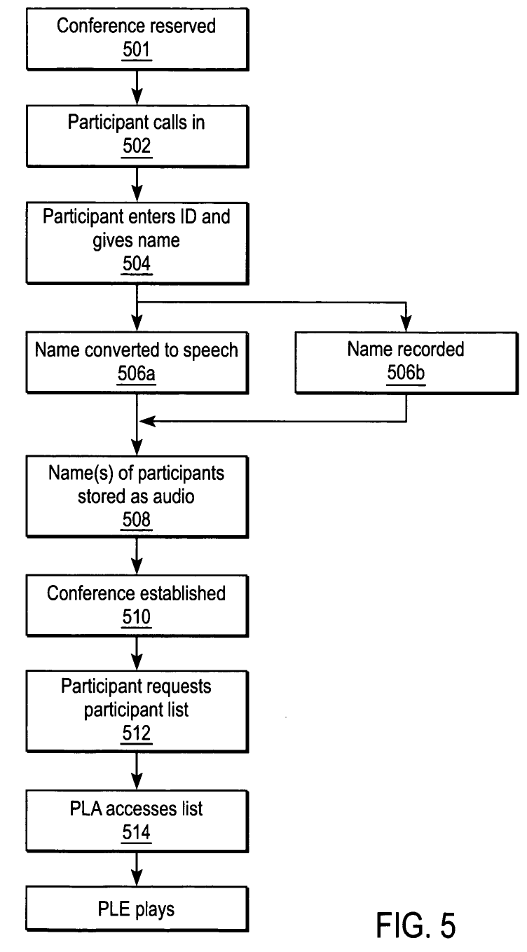

Turning now to FIG. 5, a flowchart 500 illustrating operation of embodiment of the present invention is shown. The particular arrangement of elements in the flowchart 500 is not meant to imply a fixed order to the elements; embodiments can be practiced in any order that is practicable.

In a step 501, a conference may be reserved. For example, a host may reserve a time and facilities with the conferencing service 102. In doing so, the host may receive a conference identification and a call in number.

At a step 502, participants call in to the server, using the call in number, and at the specified time. In a step 504, the conferencing server 102 can receive the conference identification from the caller; the caller may also be prompted to provide his name, for example, by speaking it or entering it using a keypad or other input device.

At a step 506, the user is registered as a participant and his name is either recorded (step 506b) or, if provided as text, converted to speech (step 506a) using TTS engine 106. The resulting names of participants may be stored by the conferencing service 102 or the participant list agent 104 as one or more audio files in a suitable memory location. If a single file is stored, it may be updated as new parties join the conference.

In a step 510, the conference is established by the conferencing service 102. For example, this can include appropriate identification of parties and mixing or communication channels.

At a step 512, participant list agent can receive a request for a participant list. As noted above, a user may make use of a participant client list application 114 to send one or more request signals to the participant list agent 104. This may include, for example, DTMF signaling or signaling through a browser interface, or any other suitable signaling.

In a step 514, the participant list agent 104 can access, or cause the conferencing service 102 to access the list of active participants. Finally, in a step 516, the participant list agent 104 can play or cause the conferencing service to play the list for the requesting party. As noted above, this can include the conferencing service 102 mixing the list audio stream with the ongoing conference for the requesting party.

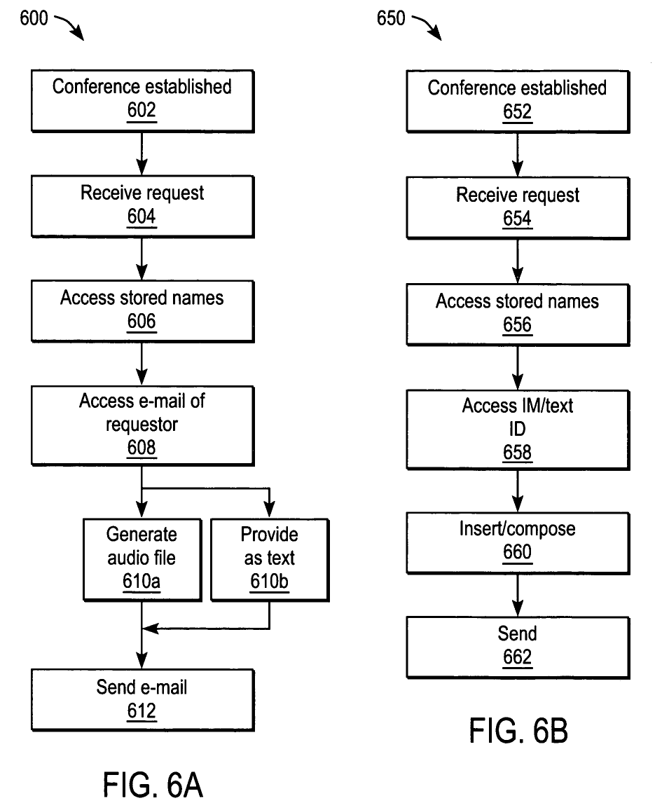

Turning now to FIG. 6A, a flowchart 600 illustrating operation of embodiment of the present invention is shown. The particular arrangement of elements in the flowchart 600 is not meant to imply a fixed order to the elements; embodiments can be practiced in any order that is practicable.

In a step 602, a teleconference may be established via the conferencing server 102. As discussed above, it may be established, for example, by a “dialing out” or a “meet me” method.

In a step 604, the participant list agent 104 may receive a request for a participant list. In a step 606, the participant list agent 102 will access or cause to be accessed, the list of active participant names.

In a step 608, the participant list agent 104 accesses the requesting party's messaging system address, such as an e-mail address. The messaging system address may be provided, either by the user during or upon entry to the conference, or by the host, or may otherwise be available to the system. Then depending on the embodiment, an audio file of the active participant list may be accessed or generated, as shown at step 610a, or a text file of the participant list may be accessed or generated, as shown at step 610b.

Finally, at a step 612, the participant list agent 104 may cause the e-mail service 118 to generate an e-mail to the requesting party. The e-mail may include the requested participant list information. For example, it could be provided as an audio or text file attachment or it can be provided in-line in the body of the e-mail.

FIG. 6B illustrates a flowchart 650 of another embodiment of the present invention. The particular arrangement of elements in the flowchart 650 is not meant to imply a fixed order to the elements; embodiments can be practiced in any order that is practicable.

In a step 652, a teleconference may be established via the conferencing server 102. As discussed above, it may be established, for example, by a “dialing out” or a “meet me” method.

In a step 654, the participant list agent 104 may receive a request for a participant list. In a step 656, the participant list agent 102 will access or cause to be accessed, the list of active participant names.

In a step 658, the participant list agent 104 accesses the requesting party's text messaging system address or identifier, such as an Instant Messaging address. The messaging system address may be provided, either by the user during or upon entry to the conference, or by the host, or may otherwise be available to the system. Then, in a step 660, the list may be inserted as text in a text message for the user. Finally, in a step 662, the test message may be sent to the user.

It is noted that, in other embodiments, the conferencing service 102 or the participant list agent 104 could cause a browser page to be displayed on the requesting party's browser. The display could include, for example, at text display of the active users, or a hyperlink to an audio file of the participant list.

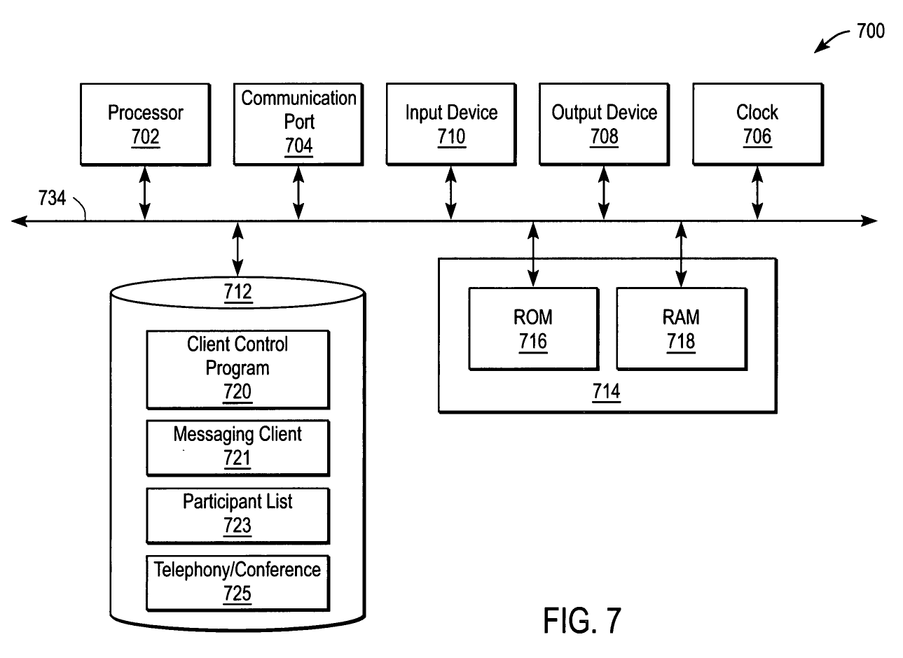

Now referring to FIG. 7, a representative block diagram of a computer or processing device 700 suitable for use as a user device according to embodiments of the present invention is shown. In some embodiments, the computer 700 may include or operate a participant list application, and may further include a telephony client, and a messaging client, such as e-mail or a text messaging system. The computer 700 may also operate a web browser program. The computer 700 may be embodied as a single device or computer, a networked set or group of devices or computers, a workstation, mainframe or host computer, etc. In some embodiments, the server 700 may implement one more elements of the methods disclosed herein.

The computer 700 may include a processor, microchip, central processing unit, or computer 702 that is in communication with or otherwise uses or includes one or more communication ports or network interfaces 704 for communicating with user devices and/or other devices. The communication ports 704 may include such things as local area network adapters, wireless communication devices, Bluetooth technology, etc. The computer 700 also may include an internal clock element 706 to maintain an accurate time and date for the computer 700, create time stamps for communications received or sent by the computer 700, etc.

If desired, the computer 700 may include one or more output devices 708 such as a printer, infrared or other transmitter, antenna, audio speaker, display screen or monitor, text to speech converter, etc., as well as one or more input devices 710 such as a bar code reader or other optical scanner, infrared or other receiver, antenna, magnetic stripe reader, image scanner, roller ball, touch pad, joystick, touch screen, microphone, computer keyboard, computer mouse, etc.

In addition to the above, the computer 700 may include a memory or data storage device 712 to store information, software, databases, documents, communications, device drivers, etc. The memory or data storage device 712 may be implemented as an appropriate combination of magnetic, optical and/or semiconductor memory, and may include, for example, Read-Only Memory (ROM), Random Access Memory (RAM), a tape drive, flash memory, a floppy disk drive, a Zip™ disk drive, a compact disc and/or a hard disk. Thus, the storage device 712 may include various combinations of moveable and fixed storage. The computer 700 also may include memory 714, such as ROM 716 and RAM 718.

The processor 702 and the data storage device 712 in the computer 700 each may be, for example: (i) located entirely within a single computer or other computing device; or (ii) connected to each other by a remote communication medium, such as a serial port cable, telephone line or radio frequency transceiver. In one embodiment, the computer 700 may be implemented as one or more computers that are connected to a remote server computer, as will be explained in greater detail below.

A conventional personal computer or workstation with sufficient memory and processing capability may be used as the computer 700. The computer 700 may be capable of high volume transaction processing, performing a significant number of mathematical calculations in processing communications and database searches. A Pentium™ microprocessor such as the Pentium III™ or IV™ microprocessor, manufactured by Intel Corporation may be used for the processor 702. Other suitable processors may be available from Motorola, Inc., AMD, or Sun Microsystems, Inc. The processor 702 also may be embodied as one or more microprocessors, computers, computer systems, etc.

Software may be resident and operating or operational on the computer 700. The software may be stored on the data storage device 712 and may include a client control program 720 for operating the computer. The client control program 720 may include a messaging client program for operating a text messaging or e-mail system; a participant list client program for allowing a user to request participant information; and a telephony/conferencing program to allow the computer to be used as a telephone and/or set up teleconferences as a host.

The client control program 720 may control the processor 702. The processor 702 may perform instructions of the client control program 720, and thereby operate in accordance with the methods described in detail herein. The client control program 720 may be stored in a compressed, uncompiled and/or encrypted format. The client control program 720 furthermore includes program elements that may be necessary, such as an operating system, a graphical user interface program, a browser, a database management system and device drivers for allowing the processor 702 to interface with peripheral devices, databases, etc. Appropriate program elements are known to those skilled in the art, and need not be described in detail herein. Information regarding other application program data may be stored in application databases (not shown)

According to some embodiments, the instructions of the control program may be read into a main memory from another computer-readable medium, such as from the ROM 716 to the RAM 718. Execution of sequences of the instructions in the control program causes the processor 702 to perform the process elements described herein. In alternative embodiments, hard-wired circuitry may be used in place of, or in combination with, software instructions for implementation of some or all of the methods described herein. Thus, embodiments are not limited to any specific combination of hardware and software.

The processor 702, communication ports 704, clock 706, output device 708, input device 710, data storage device 712, ROM 716 and RAM 718 may communicate or be connected directly or indirectly in a variety of ways. For example, the processor 702, communication ports 704, clock 706, output device 708, input device 710, data storage device 712, ROM 716 and RAM 718 may be connected via a bus 734.

While specific implementations and hardware/software configurations for the computer 700 have been illustrated, it should be noted that other implementations and hardware configurations are possible and that no specific implementation or hardware/software configuration is needed. Thus, not all of the components illustrated in FIG. 7 may be needed for the computer 700 implementing the methods disclosed herein.

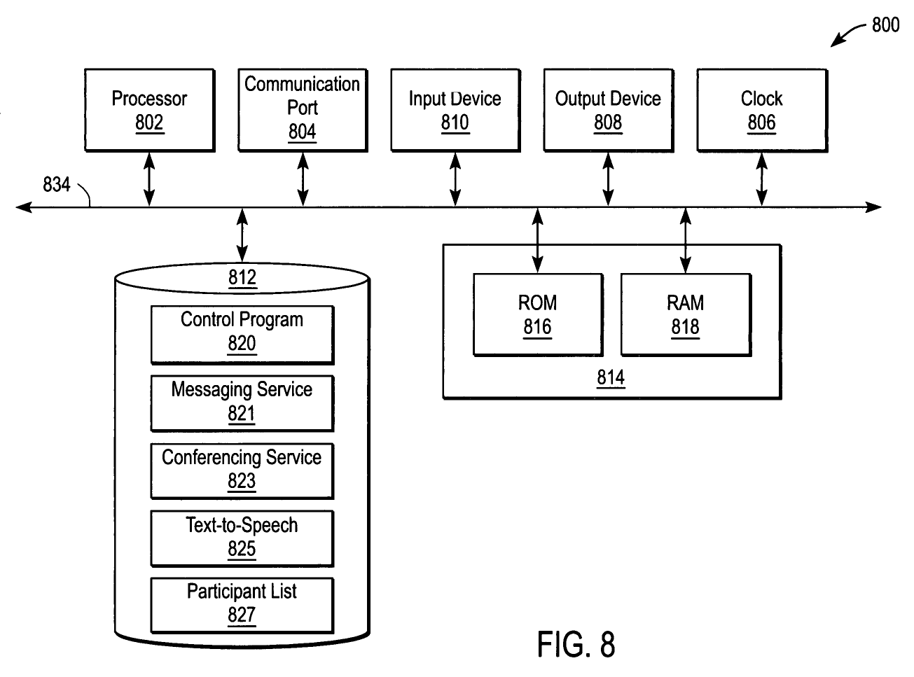

FIG. 8 is a diagram illustrating a server 800 according to embodiments of the present invention. In some embodiments, the server 800 may include or operate a teleconferencing service, a messaging service, a text-to-speech agent, and a participant list agent. Certain embodiments of the computer 800 may also include web server software or programs. The server 800 may be embodied as a single device or computer, a networked set or group of devices or computers, a workstation, mainframe or host computer, etc. In some embodiments, the server 800 may implement one more elements of the methods disclosed herein.

The server 800 may include a processor, microchip, central processing unit, or computer 802 that is in communication with or otherwise uses or includes one or more communication ports 804 for communicating with user devices and/or other devices. The communication ports 804 may include such things as local area network adapters, wireless communication devices, telephone network adapters, Bluetooth technology, etc. The server 800 also may include an internal clock element 806 to maintain an accurate time and date for the server 800, create time stamps for communications received or sent by the server 800, etc.

If desired, the server 800 may include one or more output devices 808 such as a printer, infrared or other transmitter, antenna, audio speaker, display screen or monitor, text to speech converter, etc., as well as one or more input devices 810 such as a bar code reader or other optical scanner, infrared or other receiver, antenna, magnetic stripe reader, image scanner, roller ball, touch pad, joystick, touch screen, microphone, computer keyboard, computer mouse, etc.

In addition to the above, the server 800 may include a memory or data storage device 812 to store information, software, databases, documents, communications, device drivers, etc. The memory or data storage device 812 may be implemented as an appropriate combination of magnetic, optical and/or semiconductor memory, and may include, for example, Read-Only Memory (ROM), Random Access Memory (RAM), a tape drive, flash memory, a floppy disk drive, a Zip™ disk drive, a compact disc and/or a hard disk. The server 800 also may include memory 814, such as ROM 816 and RAM 818.

The processor 802 and the data storage device 812 in the server 800 each may be, for example: (i) located entirely within a single computer or other computing device; or (ii) connected to each other by a remote communication medium, such as a serial port cable, telephone line or radio frequency transceiver. In one embodiment, the server 800 may be implemented as one or more computers that are connected to a remote server computer for maintaining databases.

A conventional personal computer or workstation with sufficient memory and processing capability may be used as the server 800. The server 800 may be capable of high volume transaction processing, performing a significant number of mathematical calculations in processing communications and database searches. A Pentium™ microprocessor such as the Pentium III™ or IV™ microprocessor, manufactured by Intel Corporation may be used for the processor 802. Other suitable processors may be available from Motorola, Inc., AMD, or Sun Microsystems, Inc. The processor 802 also may be embodied as one or more microprocessors, computers, computer systems, etc.

Software may be resident and operating or operational on the server 800. The software may be stored on the data storage device 812 and may include a control program 820 for operating the server, databases, etc. The control program 822 may include a messaging service program, a conferencing service program, a text-to-speech agent, and a participant list program.

The control program 822 may control the processor 802. The processor 802 may perform instructions of the control program 820, and thereby operate in accordance with the methods described in detail herein. The control program 822 may be stored in a compressed, uncompiled and/or encrypted format. The control program 822 furthermore includes program elements that may be necessary, such as an operating system, a database management system and device drivers for allowing the processor 802 to interface with peripheral devices, databases, etc. Appropriate program elements are known to those skilled in the art, and need not be described in detail herein.

The server 800 also may include or store information regarding identities, user devices, contexts, communications, messages, etc. Information regarding other application program data may be stored in application database (not shown). In some embodiments, some or all of one or more of the databases may be stored or mirrored remotely from the server 800.

According to some embodiments, the instructions of the control program may be read into a main memory from another computer-readable medium, such as from the ROM 816 to the RAM 818. Execution of sequences of the instructions in the control program causes the processor 802 to perform the process elements described herein. In alternative embodiments, hard-wired circuitry may be used in place of, or in combination with, software instructions for implementation of some or all of the methods described herein. Thus, embodiments are not limited to any specific combination of hardware and software.

The processor 802, communication ports 804, clock 806, output device 808, input device 810, data storage device 812, ROM 816, and RAM 818 may communicate or be connected directly or indirectly in a variety of ways. For example, the processor 802, communication ports 802, clock 806, output device 808, input device 810, data storage device 812, ROM 816, and RAM 818 may be connected via a bus 834.

While specific implementations and hardware/software configurations for the server 800 have been illustrated, it should be noted that other implementations and hardware configurations are possible and that no specific implementation or hardware/software configuration is needed. Thus, not all of the components illustrated in FIG. 8 may be needed for the server 800 implementing the methods disclosed herein.

The methods described herein may be embodied as a computer program developed using an object oriented language that allows the modeling of complex systems with modular objects to create abstractions that are representative of real world, physical objects and their interrelationships. However, it would be understood by one of ordinary skill in the art that the invention as described herein could be implemented in many different ways using a wide range of programming techniques as well as general-purpose hardware systems or dedicated controllers. In addition, in some embodiments, many, if not all, of the elements for the methods described above are optional or can be combined or performed in one or more alternative orders or sequences and the claims should not be construed as being limited to any particular order or sequence, unless specifically indicated.

Each of the methods described above can be performed on a single computer, computer system, microprocessor, etc. In addition, in some embodiments, two or more of the elements in each of the methods described above could be performed on two or more different computers, computer systems, microprocessors, etc., some or all of which may be locally or remotely configured. The methods can be implemented in any sort or implementation of computer software, program, sets of instructions, programming means, code, ASIC, or specially designed chips, logic gates, or other hardware structured to directly effect or implement such software, programs, sets of instructions, programming means or code. The computer software, program, sets of instructions or code can be storable, writeable, or savable on any computer usable or readable media or other program storage device or media such as a floppy or other magnetic or optical disk, magnetic or optical tape, CD-ROM, DVD, punch cards, paper tape, hard disk drive, Zip™ disk, flash or optical memory card, microprocessor, solid state memory device, RAM, EPROM, or ROM.

The foregoing description of the invention has been presented for purposes of illustration and description. It is not intended to be exhaustive or to limit the invention to the precise form disclosed, and modifications and variations are possible in light of the above teachings or may be acquired from practice of the invention. The drawings and description were chosen in order to explain the principles of the invention and its practical application. The drawings are not necessarily to scale and illustrate the device in schematic block format. It is intended that the scope of the invention be defined by the claims appended hereto, and their equivalents

What is claimed is:

1. A telecommunications apparatus, comprising:
a teleconferencing service; and
a participant list announcement service operably coupled to the teleconferencing service and configured to announce the names of active participants in a teleconference to a requesting participant.

2. A telecommunications apparatus in accordance with claim 1, wherein said participant list announcement service is configured to announce the names only to the requesting party.

3. A telecommunications apparatus in accordance with claim 2, wherein said participant list announcement service is configured to announce the names aurally.

4. A telecommunications apparatus in accordance with claim 3, wherein said participant list announcement service is configured to cause an audio file to be downloaded to the requesting party, the audio file including the names of the participants for announcing aurally.

5. A telecommunications apparatus in accordance with claim 2, wherein said participant list announcement service is configured to send an e-mail containing a text list of names of participants to the requesting party.

6. A telecommunications apparatus in accordance with claim 1, wherein said participant list announcement service is configured to generate an aural list of active participants from a text list.

7. A telecommunications apparatus in accordance with claim 1, wherein said participant list announcement service is configured to generate an aural list of active participants from names directly spoken by joining participants.

8. A telecommunications apparatus in accordance with claim 6, wherein said text list is provided when a teleconference is scheduled through said teleconferencing service.

9. A method, comprising:
receiving a request for a list of active participants to a teleconference; and
providing the list to a requesting party.

10. A method in accordance with claim 9, wherein said providing comprises providing the list as an audio announcement only to the requesting party.

11. A method in accordance with claim 10, wherein said providing further comprises providing the audio announcement in the foreground while the conference is ongoing in the background.

12. A method in accordance with claim 9, wherein said providing comprises generating an e-mail including the list and sending the e-mail to the requesting party.

13. A method in accordance with claim 12, wherein the e-mail includes an audio file of the list.

14. A method in accordance with claim 12, wherein the e-mail includes a text representation of the list.

15. A method in accordance with claim 9, wherein said providing comprises generating an audio representation of a name of a participant from a textual representation.

16. A telecommunications system, comprising:
a network;
a plurality of user devices operably coupled to the network;
a teleconferencing service operably coupled to the network and configured to supervise conference calls among the plurality of user devices; and
a participant list announcement service operably coupled to the teleconferencing service and configured to announce the names of active participants in a teleconference to a requesting participant.

17. A telecommunications system in accordance with claim 16, wherein said participant list announcement service is configured to announce the names only to the requesting party.

18. A telecommunications system in accordance with claim 17, wherein said participant list announcement service is configured to announce the names aurally.

19. A telecommunications system in accordance with claim 18, wherein said participant list announcement service is configured to cause an audio file to be downloaded to the requesting party, the audio file including the names of the participants for announcing aurally.

20. A telecommunications system in accordance with claim 17, wherein said participant list announcement service is configured to send an e-mail containing a text list of names of participants to the requesting party.

21. A telecommunications system in accordance with claim 16, wherein said participant list announcement service is configured to generate an aural list of active participants from a text list.

22. A telecommunications system in accordance with claim 16, wherein said participant list announcement service is configured to generate an aural list of active participants from names directly spoken by joining participants.

23. A telecommunications system in accordance with claim 22, wherein said text list is provided when a teleconference is scheduled through said teleconferencing service.
